(19) United States
(12) Patent Application Publication
(10) Pub. No.: US 2002/0060983 A1
(43) Pub. Date: May 23, 2002

(54) Method for evaluating and configuring orthogonal frequency division multiplexing system having frequency offset

(76) Inventors: Ki Seon Kim, Kwangju (KR); Woon Cheol Hwang, Kwangju (KR)

Correspondence Address: BACON & THOMAS, PLLC, 4th Floor, 625 Slaters Lane, Alexandria, VA, 22314-1176, US

(21) Appl. No.: 09/778,073

(22) Filed: Feb. 7, 2001

(30) Foreign Application Priority Data
Oct. 17, 2000 (KR) 10-2000-61077

(51) Int. Cl. H04J 11/00

(52) U.S. Cl. 370/208

(57) ABSTRACT

The present invention relates to a method for evaluating and configuring orthogonal frequency division multiplexing (OFDM) system having frequency offset. More specifically, the invention relates to techniques useful for evaluating the performance of and configuring an OFDM system under circumstances where carrier frequency offset exists between the transmitter and the receiver in shadowed multi-path channels.

The conventional art for multi-path channels fails to reliably establish a direct correlation between the SNR degradation and the frequency offset, and, therefore, reveals a problem that the effect of the frequency offset is not clearly comprehended.

In resolving this drawback, the present invention provides an evaluating and configuring method of OFDM system on shadowed multi-path channels by adopting an approximation scheme in obtaining the SNR degradation due to the carrier frequency offset and expressing the SNR degradation as an explicit function of frequency offset and other channel/system parameters of the OFDM system.

Therefore, the present invention allows one to comprehend the effect of frequency offset on OFDM system on multi-path channels, more easily but with accuracy comparable to the conventional evaluation method, and yields an effect of providing a design index in designing a carrier frequency recovery circuit of OFDM receiver.

### BACKGROUND OF THE INVENTION

1 . Field of the Invention

The present invention relates to a method for evaluating and configuring orthogonal frequency division multiplexing (OFDM) system having frequency offset. More specifically, the invention relates to techniques useful for evaluating the performance of and configuring an OFDM system under circumstances where carrier frequency offset exists between the transmitter and the receiver in shadowed multi-path channels.

2 . Description of the Related Art

Generally, OFDM is a multi-carrier transmission method that utilizes bandwidth efficiently by overlapping the spectra of subcarriers. In this technique, sub-carriers can be separated each other in the receiver even with the overlapped spectra by orthogonality constraints imposed among the multiplexed subcarrier frequecies.

Especially, the OFDM scheme is very effective for high-speed communication on multi-path channels. In the transmitter of OFDM system, serial input data are converted into parallel data which are distributed to a plurality of orthogonal subcarriers within the available frequency bandwidth, so that a low-speed data transmission is allowed on each subcarrier.

Therefore, OFDM scheme can eliminate or significantly reduce the intersymbol interference that causes problems in high-speed communication on multi-path channels.

However, OFDM scheme has several drawbacks, one of which is a higher susceptibility to carrier frequency offset, comparing with that of single carrier system. This high susceptibility is attributed to the very nature of the structure of OFDM system.

The spacing between subcarriers in the OFDM scheme is made much narrower by packing a multiplicity of subcarriers in a given frequency bandwidth, and thus the allowable frequency offset is reduced accordingly. Therefore, a given amount of frequency offset causes a much more adverse effect for an OFDM system than an equivalent single carrier system using the same frequency bandwidth.

For example, if an uncompensated frequency offset exists, desired signal component in the received signal not only decreases, but interchannel interference component arises additionally or increases. This leads to signal-to-noise ratio (SNR) decrease, and then system performance degradation.

Thus far, various techniques have been developed to evaluate the performance of OFDM system having frequency offset. One such technique is to evaluate the effect of frequency offset in an OFDM system by obtaining a correlation between the frequency offset and the SNR on additive white Gaussian noise (AWGN) channels. Techniques for multi-path channels similar to those for AWGN channels have also been developed.

However, the conventional art for multi-path channels fails to reliably establish an explicit relationship between the SNR degradation and the frequency offset, and, therefore, reveals a problem that the effect of the frequency offset is not clearly comprehended.

### SUMMARY OF THE INVENTION

It is an object of the present invention to resolve the aforementioned problems by providing a method to evaluate and configure an OFDM system having frequency offset. In the present invention, the performance degradation is obtained for the OFDM system with carrier frequency offset on shadowed multi-path channels, and the quantitative effect of frequency offset on the OFDM system performance on said channels is evaluated definitely, allowing an optimum configuring of the system.

To achieve the object of the invention, the OFDM system evaluation method according to the present invention adopts an approximation scheme in obtaining the SNR degradation due to the frequency offset in the receiving part, and expresses the SNR degradation as an explicit function of frequency offset and other channel/system parameters of the OFDM system having carrier frequency offset on shadowed multi-path channels.

The above and other features and advantages of the present invention will be more clearly understood for those skilled in the art from the following detailed description taken in conjunction with the accompanying drawings.

### BRIEF DESCRIPTION OF THE DRAWINGS

FIG. 1 is a schematic representation of a typical OFDM system model, which is taken as a model to apply the OFDM system performance evaluation method according to the present invention.

FIG. 2 is a diagram of shadowed multi-path channel, which is taken as a model to apply the OFDM system performance evaluation method according to the present invention.

FIG. 3 shows the sensitivity of the SNR degradation of OFDM system plotted over Eₛ/Nₒ due to frequency offset on shadowed multi-path channels.

FIG. 4 compares the SNR degradations due to frequency offset for case of single carrier system, case of OFDM system evaluated by the conventional method, and case of OFDM system evaluated by the method according to the present invention.

### DETAILED DESCRIPTION OF THE EMBODIMENT

Hereinafter, the constitution and operation of an embodiment according to the present invention is described in detail by referring to the accompanying drawings.

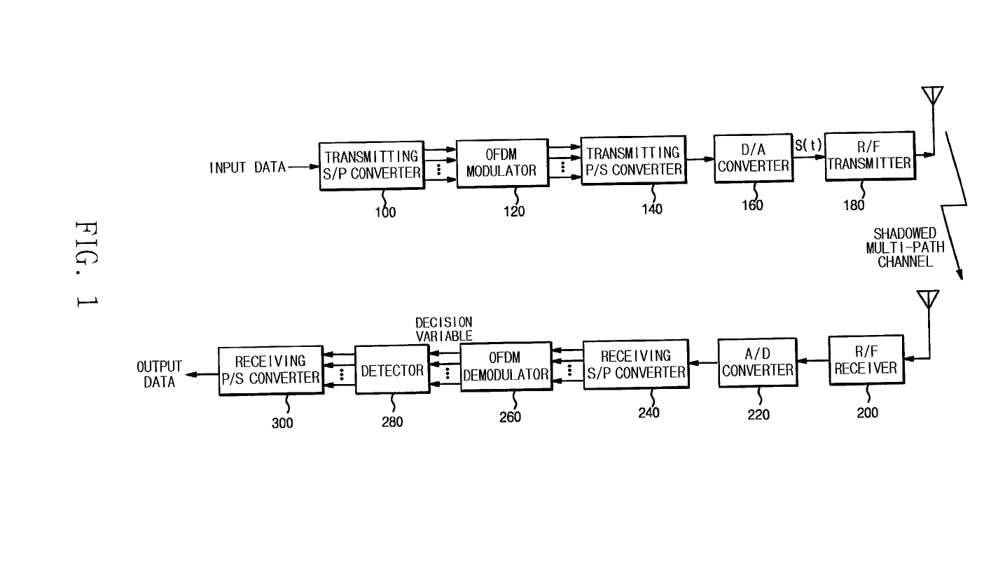

FIG. 1 is a schematic representation of a typical OFDM system model, comprising three parts: transmitter, channel, and receiver, which is taken as a model to apply the OFDM system performance evaluation method according to the present invention.

The transmitting part of OFDM system comprises; transmitting serial/parallel converter (100), OFDM modulator (120), transmitting parallel/serial converter (140), digital/analog converter (160), and radio frequency (RF) transmitter(180).

The receiving part of OFDM system comprises; RF receiver (200), analog/digital converter (220), receiving serial/parallel converter (240), OFDM demodulator (260), detector (280), and receiving parallel/serial converter (300).

The operational process of the OFDM system shown in FIG. 1 is as follows. The serial data symbols inputted into the transmitter is converted into parallel form by the serial/parallel converter(100), thereby modulating subcarriers. The modulated subcarriers are integrated and transmitted on RF carriers through the channels. This modulation process is actually performed using the inverse fast Fourier transform (IFFT) algorithm.

If there exists a frequency offset between the transmitter and the receiver, the complex amplitude of the transmitted OFDM signal is represented by the following equation (1):

$$s ( t ) = {ⅇ}^{j2π Ft} {\sum }_{n = - ∞}^{∞} {\sum }_{i = 0}^{N - 1} \frac{A}{\sqrt{T}} {a}_{n , i} {ⅇ}^{j2π {f}_{i} t} p ( t - nT ) , \qquad ( 1 )$$

where F is the frequency offset of carrier, N is the number of subcarriers, A is the constant associated with power of the signal, T is the period of the OFDM symbol, a_{n,i} indicates the data symbol in the n-th interval transmitted by the i-th subcarrier, fᵢ is the frequency of the i-th subcarrier, and p(t) represents the rectangular pulse with amplitude of 1 and period of T, respectively.

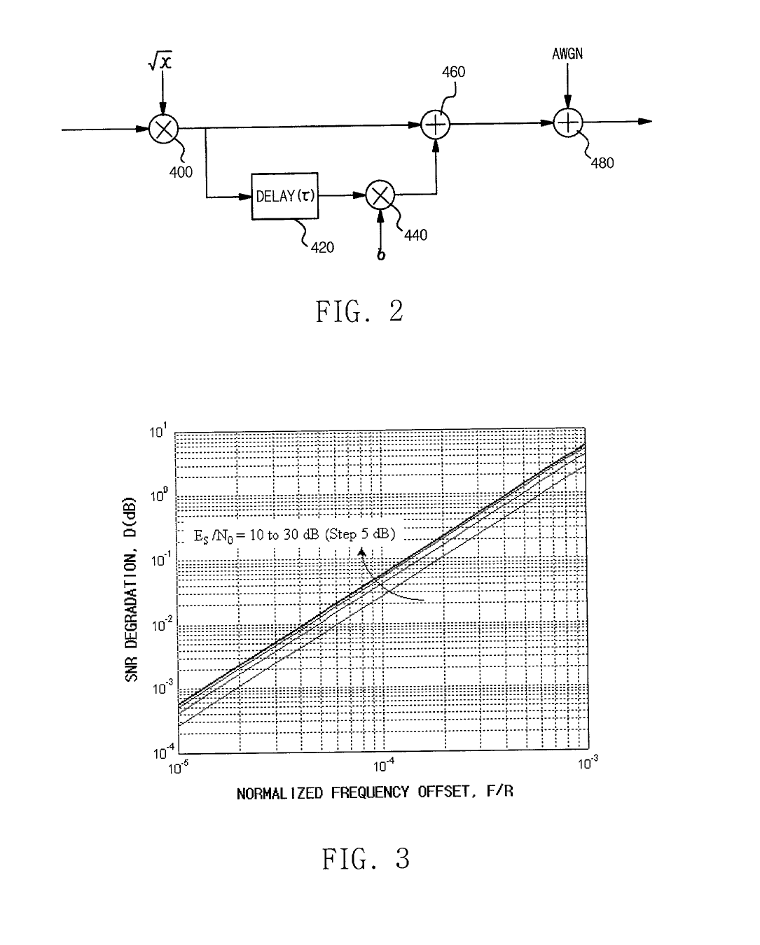

The OFDM signal represented by the above equation (1) is transmitted through radio channels into the receiving part. The channel considered as an example in the invention is shadowed 2-path channel, the detailed structure of which is shown in FIG. 2.

Referring to the structure of FIG. 2, the channel comprises first multiplier (400) multiplying \sqrt{X}, delay (420) with delay time τ, second multiplier(440) with attenuation coefficient b, first adder(460), and second adder(480) adding additive white Gaussian noise (AWGN).

The impulse response of the aforementioned channel is represented by the following equation (2):

h(t)=\sqrt{X}[δ(t)+bδ(t-τ)], (2)

where x is log-normal random variable representing shadow fading, b and τ are attenuation coefficient and delay time of the delay path, respectively.

Referring to FIG. 1, the signals received in the RF receiver(200) through said channel are multiplied by the frequency of the RF carrier wave, falling into the baseband, then passed through a bank of correlators. In the actual realization, this step is carried out by fast Fourier transform (FFT). Finally, detected symbols are converted into a serial form by receiving parallel/serial converter (300), then conveyed to recipient.

In the receiving part, decision variables formed after passing trough correlators comprises component of desired signal, intersymbol interference, interchannel interference, and background noise. Among these, the interchannel interference can be broken down further into two components: one from the direct path and the other from the delay path. The former component is developed only because of the frequency offset and is the main source of degrading the performance of OFDM system.

In the present invention, the criterion to evaluate the performance of OFDM systems is chosen to be the SNR degradation in the receiving part, which is defined as the difference in dB unit between the received SNR without frequency offset and that with frequency offset. To obtain the SNR degradation, it is required to obtain powers of all the components that constitute the decision variables.

Among these, interchannel interference takes the most complicated form. If we use this directly, the equation representing the SNR degradation becomes too complicated, so that it becomes difficult to comprehend the effects of frequency offset and other various parameters on the system.

Therefore, it is essential to express the power of interchannel interference component by a simpler form using proper approximation.

The approximation is based on the following two observations.

First, while interchannel interference caused by adjacent channels is large, that by distant channels is small. Second, the number of subcarriers used in general OFDM systems is sufficiently large, ranging as many as several tens to several hundreds.

Using above two observations, an approximated expression for power of interchannel interference component is obtained in a relatively simple form, and then used in obtaining the SNR degradation in the receiving part.

The SNR degradation obtained in the above procedure takes a form containing log and sine functions. Since receivers of communication systems normally contain circuits to compensate carrier frequency offset, the frequency offset remained uncompensated is not so large.

Therefore, it is assumed that frequency offset is much smaller than OFDM symbol transmission rate. Under this assumption, by applying Taylor series expansion to log and sine functions, the SNR degradation (D) is expressed by the following equation (3):

$$D ≅ \frac{10 {π}^{2}}{3 ln 10} {{N}^{2} ( \frac{F}{R} )}^{2} {E}_{x} [ {( {b}^{2} + \frac{1}{2 x ( {E}_{s} / {N}_{0} )} )}^{- 1} ] , \qquad ( 3 )$$

where R is the transmission rate of input data symbol, the value of which is obtained by dividing the number of subcarriers (N) by OFDM symbol period (T), Eₛ is average transmission energy per input data symbol, N₀ is power density of background noise, and Eₓ[.] means algorithm that takes average over x of the value in the bracket, respectively.

Referring Equation 3, the SNR degradation (D) is found to be proportional to the square of the frequency offset and the square of the number of subcarriers.

Also, it is found that, though not an exact proportionality, SNR degradation (D) increases as the value of Eₛ/Nₒ increases or b decreases.

Considering the typical wireless communication cases for Equation 3, since b² is very large compared to 1/(2x Eₛ/Nₒ), the effect of Eₛ/Nₒ on the SNR degradation (D) is insignificant. In other words, the SNR degradation (D) is said not to be sensitive to Eₛ/Nₒ.

Therefore, if the value of Eₛ/Nₒ,is sufficiently large, Equation 3 is further approximated as in the following equation (4):

$$D ≅ \frac{10 {π}^{2}}{3 ln 10} \frac{{N}^{2}}{{b}^{2}} {( \frac{F}{R} )}^{2} . \qquad ( 4 )$$

The above equation (4) clearly shows the explicit relationship between the SNR degradation (D) and various system parameters.

In other words, it is found from Equation 4 that the SNR degradation (D) of OFDM system having frequency offset on shadowed multi-path channels has nothing to do with the value of Eₛ/Nₒ, but it is proportional to the square of the number of subcarriers (N) and the square of the normalized frequency offset (F/R), and is inversely proportional to the square of the attenuation coefficient (b) of delay path.

Recalling the previous research results that the SNR degradation (D) on additive white Gaussian noise (AWGN) channels is proportional to Eₛ/Nₒ, it should be a remarkable characteristic that the SNR degradation (D) on multi-path channels has nothing to do with the value of Eₛ/Nₒ.

Equation 4 can be used as the design index when a carrier frequency recovery circuit is designed for OFDM system operable on shadowed multi-path channels. If the received SNR is determined to meet the bit error probability required for the system, the maximum permissible frequency offset can be determined by use of Equation 4.

The maximum permissible frequency offset thus determined is used as the design criterion when a carrier frequency recovery circuit is designed for the receiver on multi-path channels.

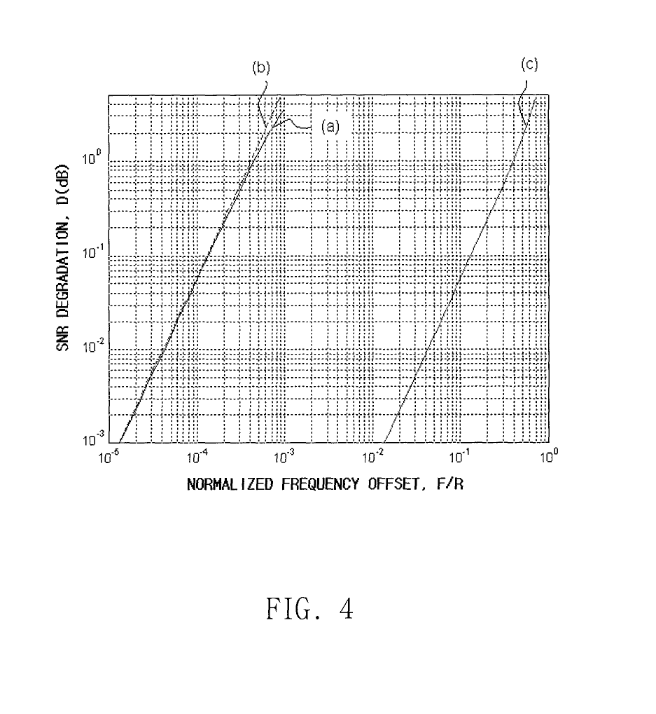

FIGS. 3 and 4 show the relationship between the SNR degradation (D) and the frequency offset in an OFDM system operating on shadowed multi-path channels.

In these figures, the OFDM system was assumed to use 128 subcarriers. Parameter values are of a typical millimeter wave channels; i.e., attenuation coefficient (b) of delay path and normalized delay time (τ/T) are set to 0.2 and 0.03, and average and standard deviation of the shadow fading are set to 0 dB and 3.2 dB, respectively.

FIG. 3 shows the sensitivity of the SNR degradation (D) over Eₛ/Nₒ due to frequency offset, plotted based on Equation 3.

Referring FIG. 3, if Eₛ/Nₒ is greater than 20 dB, it shows nearly no change in the SNR degradation (D) even with additional increase of Eₛ/Nₒ. Therefore, if frequency offset is much smaller than OFDM symbol transmission rate and Eₛ/Nₒ is sufficiently large, it is quite adequate to replace Equation 3 with Equation 4.

FIG. 4 shows the change of SNR degradations over frequency offset in an OFDM system and a single carrier system. The two curves on the left of the figure are for OFDM system. The dashed line (curve (b) in FIG. 4) is the result obtained using Equation 4; the solid line (curve (a) in FIG. 4) is the result obtained by the conventional evaluation method. Here, the value of Eₛ/Nₒ was chosen to give a symbol error probability of 10⁻⁵ for QPSK signals.

Meanwhile, the curve on the right (curve (c) of FIG. 4) shows the SNR degradation of a single carrier system, which uses the same bandwidth as the OFDM system, so that it can be used as a reference for comparing with OFDM system.

As shown in FIG. 4, the SNR degradation is severe for OFDM system, comparing with the equivalent single carrier system using the same bandwidth. To obtain the same SNR degradation, about 1000 times smaller frequency offset is required for OFDM system.

Meanwhile, as can be noticed by comparing the solid line (curve (a)) and the dashed line (curve (b)) in FIG. 4, the evaluation method proposed by the present invention yields the almost identical results with the conventional evaluation method, if the normalized frequency offset (F/R) is less than 0.001. This proves the adequacy of the evaluation method developed in the present invention.

As explained above, the method evaluating and configuring OFDM systems according to the present invention has the effect of enabling to more clearly evaluate the effect of frequency offset on OFDM system by expressing the SNR degradation of OFDM system as an explicit function of frequency offset and other system/channel parameters by use of an appropriate approximation on shadowed multi-path channels, and the effect of providing a design index in designing a carrier frequency recovery circuit of OFDM receiver.

Although the present invention has been described and illustrated in connection with the specific embodiments, it will be apparent for those skilled in the art that various modifications and changes may be made without departing from the idea and scope of the present invention delineated in the accompanying claims.

What is claimed is:

1. A performance evaluation method for OFDM (Orthogonal Frequency Division Multiplexing) system having carrier frequency offset operating on shadowed multi-path channels; said OFDM system comprising transmitter, shadowed multi-path channel, and receiver; includes
a step of obtaining the received SNR (Signal-to-Noise Ratio) degradation due to frequency offset by adopting an approximation scheme.

2. The method of claim 1, wherein said SNR degradation (D) of OFDM system due to frequency offset is given by the followung equation:
$$D ≅ \frac{10 {π}^{2}}{3 ln 10} \frac{{N}^{2}}{{b}^{2}} {( \frac{F}{R} )}^{2} ,$$
where N is the number of subcarriers, b is the attenuation coefficient of delay path, F is the frequency offset between transmitting and receiving carriers, and R is the input data transmission rate, respectively.

3. The method of claim 1, wherein the SNR degradation of OFDM system is obtained by said approxiamtion scheme under the condition that interchannel interference caused by adjacent channels is large, while that by distant channels is small, and the number of subcarriers used in said OFDM system ranges from several tens to several hundreds.

4. A configuring method for OFDM system having carrier frequency offset operating on multi-path channels exposed to shadow fading; said OFDM system comprising transmitter, shadowed multi-path channel, and receiver; is characterized
in obtaining the SNR degradation of OFDM system due to frequency offset based on the number of subcarriers, frequency offset normalized by the input data transmission rate, and the attenuation coefficient of delay path, and making said SNR degradation irrelevant to the value of Eₛ/Nₒ.
